(19) United States
(12) Patent Application Publication
(10) Pub. No.: US 2010/0179949 A1
(43) Pub. Date: Jul. 15, 2010

(54) METHOD AND SYSTEM FOR AN INTERNET BROWSER ADD-ON PROVIDNG SIMULTANEOUS MULTIPLE INTERACTIVE WEBSITES ON ONE INTERNET BROWSER WINDOW

(76) Inventor: SAMIR H. SAFAR, SAN DIEGO, CA (US)

Correspondence Address: WHITE-WELKER & WELKER, LLC, P.O. BOX 199, CLEAR SPRING, MD, 21722-0199, US

(21) Appl. No.: 12/688,478

(22) Filed: Jan. 15, 2010

Related U.S. Application Data
(60) Provisional application No. 61/205,109, filed on Jan. 15, 2009.

(51) Int. Cl. G06F 3/048; G06F 17/30

(52) U.S. Cl. 707/707; 715/760; 715/781; 715/800; 715/784; 707/E17.108

(57) ABSTRACT

The present invention describes a system and method of displaying website pages and comprises a method of Internet browser add-ons or a web-based program where the multi-pages of an Internet website are displayed partially on one window screen in multi-columns format, each column represents one website page of data. The invention is particularly, but not exclusively, useful as a system and methods with novel aspect to develop the Internet browser view more user friendly to the users and includes further a Download module to user computer and an Install/Remove module of the add-on software module.

### CROSS REFERENCE TO RELATED APPLICATIONS

This application claims priority from U.S. Provisional Patent Application Ser. No. 61/205,109, entitled “Internet Browser add-on—multiple interactive websites on one internet browser window of any internet browser simultaneously”, filed on 15 Jan. 2009. The benefit under 35 USC §119(e) of the United States provisional application is hereby claimed, and the aforementioned application is hereby incorporated herein by reference.

This is related to U.S. Provisional patent application Ser. No. 12/639,861, entitled “SYSTEM AND METHOD OF MULTI-PAGE DISPLAY AND INTERACTION OF ANY INTERNET WEBSITE PAGE DATA ON AN INTERNET BROWSER”, filed on 16 Dec. 2009. The benefit under 35 USC §119(e) of the United States provisional application is hereby claimed, and the aforementioned application is hereby incorporated herein by reference.

This application is related to U.S. Provisional Patent Application Ser. No. 61/203,058, entitled “Internet Browser Multi-Webpage Display on One Screen Add-On Computer Software Module”, filed on 18 Dec. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention pertains to generally to systems and method of Internet browser add-ons where multiple websites of any website page gets displayed and interacted with simultaneously on one Internet browser window screen in multi-columns or window format. The invention is particularly, but not exclusively, useful as a system and methods of system with novel aspect to fortify development of Internet browser view.

### BACKGROUND OF THE INVENTION

The Internet is a valuable resource for providing users with information. In particular, consumers use the Internet to find information and make decisions among online entities such as websites, online merchants, online companies, or online services. Further, the Internet is evolving into a type of informational utility that helps the people to make important decisions and manage their day-to-day activities and needs. However, the amount of information available online is so large that it may be difficult to find relevant information.

The way Internet Browsers such as MICROSOFT EXPLORER, FIREFOX and GOOGLE CHROME display of information is a problem that people face every day when they search for particular information. It is difficult to view more than on website simultaneously without opening another thread, browser window, or tab within a browser which takes more of the computer processing resources and they pages are typically stacked one behind the other.

What is needed is an add-on model for the next generation of Internet browsers that provides for the interaction and display of information, which not only solves the major multi-website display problems, but also reduces the cost and time a computer user spends finding and comparing information.

### SUMMARY OF THE INVENTION

The present invention describes a system and method of displaying website pages and comprises a method of Internet browser add-ons where the multi-page of the Internet website page data is displayed partially on one window screen in multi-columns format, each column represents one website page of data. The invention is particularly, but not exclusively, useful as a system and methods with novel aspect to develop the Internet browser view more user friendly to the users and includes further a Download module to user computer and an Install/Remove module of the add-on software module. A column configuration display of Internet website page such GOOGLE, YAHOO, or MSN/BING that display multi-page on one window screen. The computer mouse drags the edge of each column to left or right of the window screen to increase or decreases the width of the columns. The present invention can display multi listing of any website pages on one browser window.

The main components of the present invention include an add-on software module to an Internet browser, that is download via a software module to a user's computer for execution, and includes an install/remove module of the add-on software module. The physical apparatus required to enable one embodiment of the present invention includes a web server; a web portal interface; a multi-user network; and an application server.

The program module is an add-on to a browser; a User can select one, two, three, or more columns to be displayed when surfing the Internet. Each column represents one website page of data. It is downloaded from a server that on the Internet. It interfaces with MS EXPLORER, FIREFOX, SAFARI and GOOGLE CHROME. Users can condense or expand the column by clicking and dragging on the side border, left or right, to read more of the text of a specific column. Additionally, a user can use the top scroll of each column to view more of the page without expanding the columns. The top scroll was developed so a user does not have to scroll to the bottom of a column to engage a scroll feature every time.

Businesses invest huge amount of money to have multi web pages displayed and interacted with by purchasing software and computer terminals to display and interact with multi website simultaneously, such as stock market, research and development, or marketing business. Currently, Internet users have to click back and forth between Internet Browser's tabs to view web pages of the same or different website for review, study or shopping comparison.

Additionally, currently Internet users have to open multi-browser windows to view more than website at the same time on their computer screen.

Therefore it is an objective of the present invention to teach a display multi listing of any website pages on one browser window.

It is another objective of the present invention to teach a method for displaying and interacting with multiple website of any site pages on one Internet browser window.

It is yet another objective of the present invention to teach a method the will require less computer processing resource needed, since we open only one Internet browser to view multi website simultaneously.

It is still another objective of the present invention to teach a system and method where a user can see more than one website at one time.

Therefore what is needed is an Internet website page display of information, that will not only solve the major problems previously discussed, but will reduce the cost of paying for such related services. Businesses will reduce the time and money surfing and searching the Internet for research and information comparison. This will result in less terminals needed to display and interact with or to be purchase to interact with multiple websites.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 illustrates the components of the Internet Browse add-on module of the present invention where two websites are interacted with and viewed at the same time;

FIG. 2 illustrates the components of this Internet Browse add-on module of the present invention;

FIG. 3 is a flow chart illustrating the process of visiting and viewing multiple websites for at the same time; and

FIG. 4 is a flow chart illustrating the Vertical and Top Scrollbars Logic.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

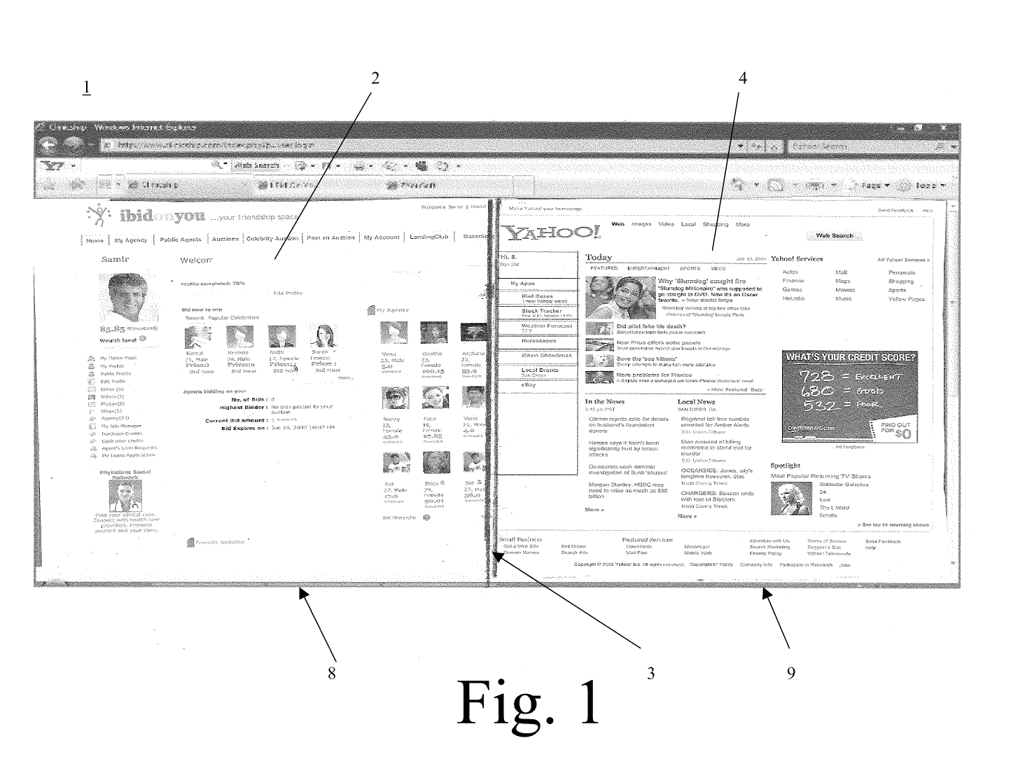

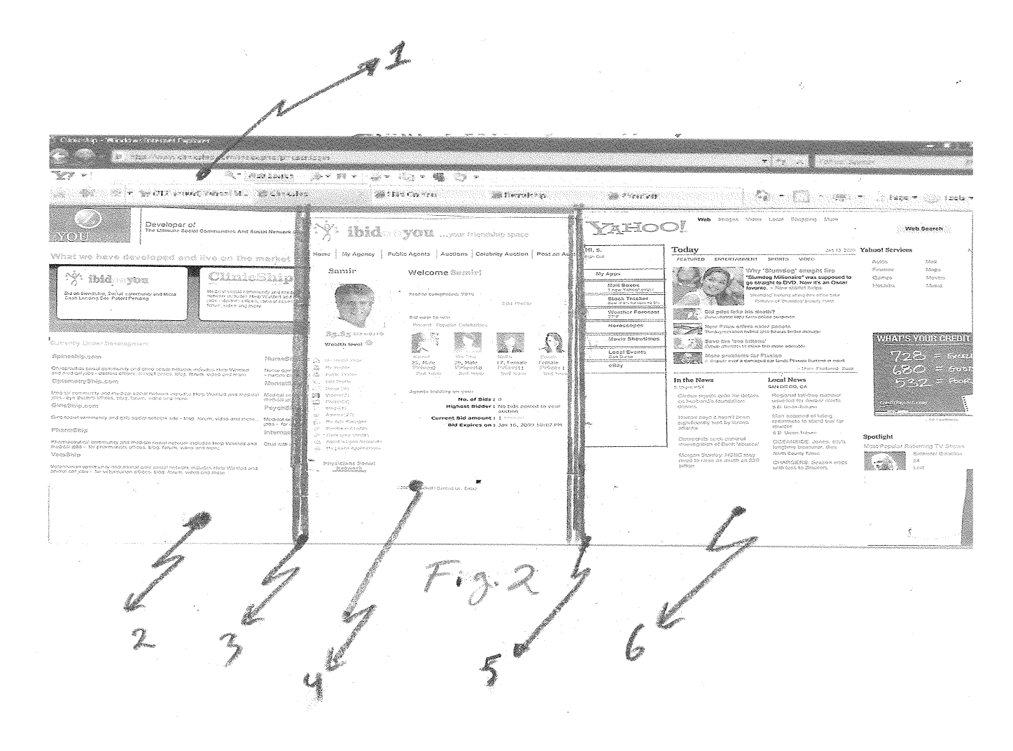

The main components of the present invention, as shown in FIGS. 1 and 2, include the Main Internet browser screen 1 and its commands menu and add-ons menu buttons, a first page of a first website off the Internet 2, a second first page from a second, different website off the Internet 4, a third first page from a third, different website off the Internet 6, and a plurality of columns boundaries 3 and 5. The first boundary 3 separates the first page of a first website off the Internet 2 from the second page from a second, different website off the Internet 4. The second boundary 5 separates the second page from a second, different website off the Internet 4 from the third page from a third, different website off the Internet 6.

The physical apparatus required to enable one embodiment of the present invention includes a web server; a web portal interface; a multi-user network; and an application server. The application server provides a means for allowing a local user computer to download and install the add-on software module taught by the present invention to any Internet browser.

The method of the present invention may also be recorded onto a CD, or any other recordable medium as well as being delivered electronically from a database to a computer, wherein the method embodied by the software that is recorded is then executed by a computer for use and transformation of the Internet browser and its contents.

Now referring to FIG. 1, the embodiment of the system and method of multi-page display and interaction of any website on an Internet browser is shown. FIG. 1 illustrates the components of this module add-on. The components of the present invention shown in FIG. 1 are: a main Internet browser screen 1, a plurality of columns of pages 8 and 9 corresponding to a first page of a first website 2 and a second first page of a second website 4, and a column boundary 3.

As shown in FIG. 1, the present invention describes a system and method of displaying websites and comprises a method of Internet browser add-ons where the pages of a plurality of website found on the Internet are displayed partially on one window screen in a multi-column format, each column represents one website page. The invention is particularly, but not exclusively, useful as a system and methods with novel aspect to develop the Internet browser view more user friendly to the users and includes further a Download module to user computer and an Install/Remove module of the add-on software module.

FIG. 1 illustrates a column configuration display for two different websites, that displays multi-pages, one form each website, on one window screen. By using a computer mouse one can drag the edge of each column 8 or 9 to left or right of the window screen to increase or decreases the width of the columns. The present invention displays multi-website pages on one browser window 1.

The visual result of the present invention is the return of multiple websites in a single page with the original look of the website pages. Multiple websites are oriented side by side. This offers better visibility of websites in the frame with a smaller size.

The program module is an add-on to a browser; a User can select a plurality of columns to be displayed when searching websites. Each column represents one website page of data. The website is downloaded from a server that is located or found on the Internet. The present invention enables users to view a plurality of website pages from a plurality of websites at the same time using one browser window 1.

The present invention teaches a column configuration display to interact with different or similar Internet websites such as FACEBOOK.COM, GOOGLE.COM, YAHOO.COM or MSN.COM that interact with multi-website pages on one Internet browser window screen to be viewed at the same time.

Furthermore, the computer mouse is used to drag the edge of each column 3 and 5 that separates the websites to left or right of the Internet Browser window screen to increase or decreases the width of the columns width. In addition, a user can interact with multiple websites at the same instance of any website page on one browser window display screen.

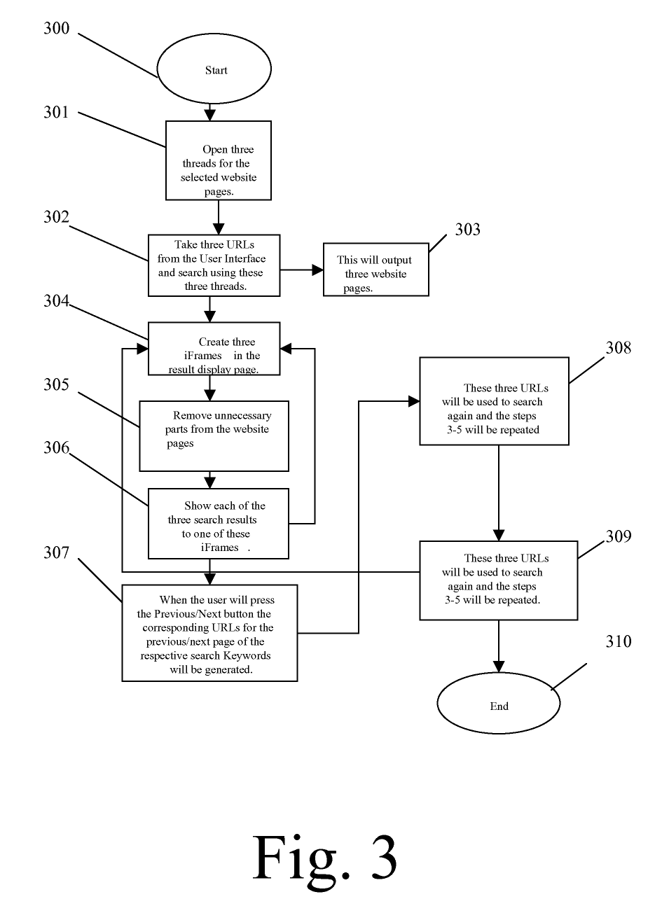

Referring to FIG. 3, the method for searching multiple websites at the same time is shown. A user starts 300 by opening three frames for the selected websites 301. Next three URL Addresses from the User Interface are taken and the pages are loaded using these three URL Addresses 303 that results in an output of three website pages 304. Three iFrames are created in the displayed website pages 304. Unnecessary parts are removed form the displayed website pages 305. Each of the three results to one of the iFrames is then shown 306 and this process is repeated for the number of iFrames previously selected and created in 304. When a user presses the previous/next button the corresponding URL for the previous/next page of the respective website is generated in step 307. The three URLs are then used to load in the next or selected pages in step 208 and steps 304, 305, and 306 are repeated 309. When all requests are complete, the process ends 310.

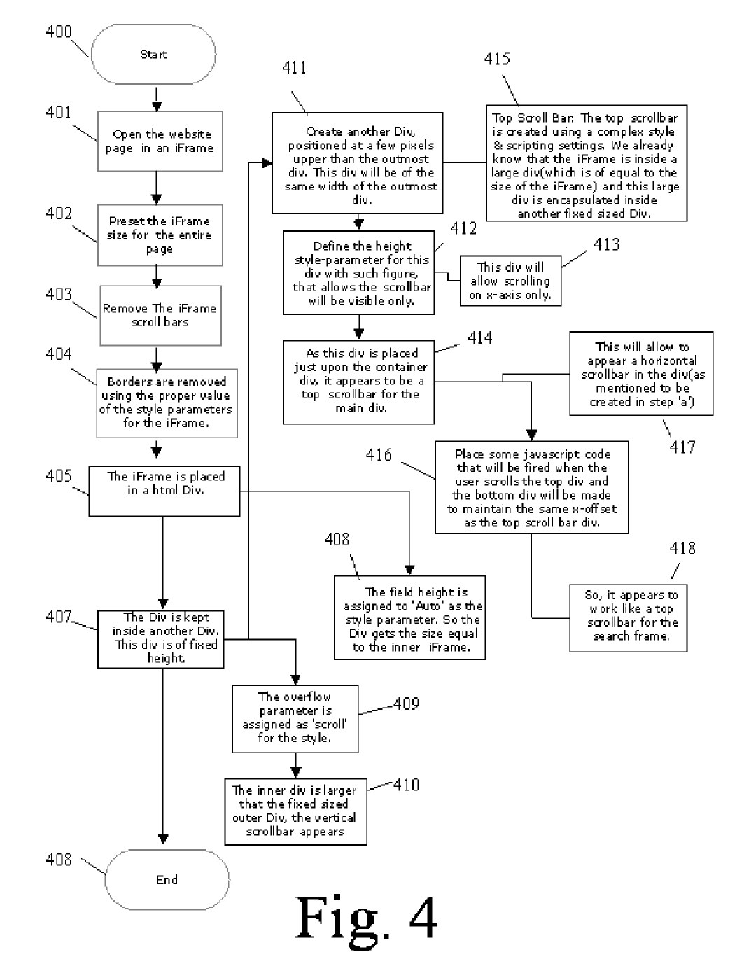

Now referring to FIG. 4, the vertical and top scrollbars logic is illustrated. The process starts 400 when the website page in an iFrame is opened 401. The iFrame size is then preset for the entire page 402 and the iFrame scroll bars are removed 403. Additionally, borders are removed using the proper value of the style parameters for the iFrame 404 and the iFrame is placed in an html Div. 405. The field height is assigned to “auto” as the style parameter so the Div. gets the size equal to the inner iFrame in step 406.

DIV tags are codes that define a section in an HTML (HyperText Markup Language) document. A section in HTML can also be described as a “division,” which is the origin of the abbreviation used for the name of the DIV tag.

DIV tags, like SPAN tags, do not apply meaning to content as is the case with most HTML For instance, “P” creates a paragraph, “B” creates boldface, and “H” creates a heading. DIV doesn't actually do anything at all by itself; it simply defines a block of content on the page to which other attributes can be globally applied. DIV tags indicate that a block of code belongs together.

In step 407 the Div. is kept inside another Div. Additionally, the overflow parameter is assigned as “scroll” for the style in step 409 and the inner Div. is larger than the fixed size of the outer Div., and the vertical scroll bar appears in step 410. This Div. is of fixed height and then the process either ends 408 or continues to created another Div. position at a few pixels upper than the outermost Div. in step 411. This Div. will be of the same width of the outermost Div. In step 415, the top scroll bar is created using a complex style and scripting settings. The iFrame is inside a large Div. which is of equal value to the size of the iFrame and this large Div is encapsulated inside another fixed size Div.

The height style parameter for the Div. created in step 411 is defined in step 412 that allows only the scroll bar to be visible and step 413 constrains this scroll bar to the x-axis only. The Div. crated in step 411 is then placed just upon the container Div in step 414 so that is appears to be a top scroll bar for the main Div. in step 415. In step 316, some javascript code that will be fired when the user scrolls the top Div. and the bottom Div. will be made to maintain the same x-offset as the top scroll bar Div. In step 417, this allows a horizontal scroll bar to appear in the Div. as created in step 401, which then appears to work as a top scroll bar for the search frame in step 418.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A computer-implemented method of multi-page display and interaction of multiple websites, the method comprising:
downloading a software module to a user's computer for execution,
running a browser on a user's computer;
opening a browser window;
running the software module as a web-based site;
visiting a plurality of websites via the browser;
loading the contents of the websites into the browser;
creating a plurality of column frames of website pages corresponding to the visited websites,
creating column boundaries dividing the websites;
orienting the websites side by side; and
displaying the websites as the original websites in each column frame of the browser window corresponding to the visited websites.

2. The method of claim 1 further comprising the step of:
representing in each column, one website page of data, and
downloading the website page of data from a server that is located or found on the Internet.

3. The method of claim 1 further comprising the step of:
displaying multiple-pages of any single website on one browser window.

4. The method of claim 1 wherein the program module is an add-on to the browser.

5. The method of claim 1 further comprising the step of:
selecting a plurality of columns to be displayed when displaying a single website.

6. The method of claim 1 further comprising the step of:
selecting one, two, three, four, or five columns to be displayed when viewing multiple website pages.

7. The method of claim 1 wherein each column represents one website and one website page of data.

8. The method of claim 1 further comprising the step of:
downloading the software module from a server on the Internet.

9. The method of claim 1 wherein each column is defined as having a top border, a bottom border, a left border, and a right border.

10. The method of claim 9 further comprising the step of:
using a computer mouse to drag the edge of each column border to the left or right of the window screen to increase or decreases the width of the columns.

11. The method of claim 10 further comprising the step of:
condensing or expanding the columns by clicking and dragging on the side border, left or right, to read more of the text of a specific column.

12. The method of claim 1 further comprising the step of:
enabling the viewing of up to five different website pages of any five websites at the same time using one browser window.

13. The method of claim 12 further comprising the step of:
searching five websites pages at the same time for any one website.

14. The method of claim 12 further comprising the step of:
searching a single page of a website from one website at the same time for three different websites.

15. The method of claim 1 further comprising the step of:
searching and viewing multiple websites at the same time using only one browser window.

16. The method of claim 1 further comprising the step of:
displaying next and previous buttons the will show the next pages of the search result,
providing a top horizontal scroll bar for each column, and
double clicking on any website page link opens that link in a new window.

17. The method of claim 1 further comprising the step of:
providing a horizontal scroll bar for each column;
displaying the horizontal scroll bar horizontally within the column between the column boundaries dividing the website pages; and
orienting the horizontal scroll bar at the top position in each frame of the column.
